(19) United States
(12) Patent Application Publication
(10) Pub. No.: US 2013/0066020 A1
(43) Pub. Date: Mar. 14, 2013

(54) Free-Radical Curable Functional Macromonomers Prepared from Anhydride

(71) Applicants: J. Scott Parent, Kingston (CA); Ralph A. Whitney, Kingston (CA); Karthik Vikram Siva Shanmugam, Vancouver (CA)

(72) Inventors: J. Scott Parent, Kingston (CA); Ralph A. Whitney, Kingston (CA); Karthik Vikram Siva Shanmugam, Vancouver (CA)

(21) Appl. No.: 13/698,123

(22) PCT Filed: May 16, 2011
(86) PCT No.: PCT/CA2011/000567

§ 371 Date: Nov. 15, 2012

Related U.S. Application Data
(60) Provisional application No. 61/345,400, filed on May 17, 2010.

(51) Int. Cl. C08F 236/08; C08F 8/00; C08F 8/20; C08F 212/08

(52) U.S. Cl. 525/332.8; 525/333.3; 525/333.4; 525/378; 525/342; 525/370; 525/366

(57) ABSTRACT

A functional macromonomer, which is an isobutylene-rich polymer that homopolymerizes when initiated by a free-radical initiator, is described that has an acrylate moiety substituted by at least one substituent that bears a functional moiety. Methods of making functional macromonomers by ring-opening various anhydrides and methods of curing functional macromonomers are described. Cured products are halo-free thermosets that have only small amounts of initiator-derived byproducts and substantially no residual unreacted functionality, which is beneficial for chemical and physical stability.

### FIELD OF THE INVENTION

The present invention relates to functional polymer compositions that can be cross-linked using radical generating techniques.

### BACKGROUND OF THE INVENTION

Poly(isobutylene-co-isoprene), or IIR, is a synthetic elastomer commonly known as butyl rubber that has been prepared since the 1940's through random cationic copolymerization of isobutylene with small amounts of isoprene (1-2 mole %). As a result of its molecular structure, IIR possesses superior gas impermeability, excellent thermal stability, good resistance to ozone oxidation, exceptional dampening characteristics, and extended fatigue resistance.

In many of its applications butyl rubber is cross-linked to generate thermoset articles with greatly improved modulus, creep resistance and tensile properties. Alternate terms for crosslinked include vulcanized and cured. Crosslinking systems that are typically utilized for IIR include sulfur, quinoids, resins, sulfur donors and low-sulfur, high-performance vulcanization accelerators. IIR can be halogenated to introduce allylic halide functionality that is reactive toward sulfur nucleophiles and toward Lewis acids such as organozinc complexes. As a result, materials such as brominated butyl rubber, or BIIR, crosslink more rapidly than IIR when treated with standard vulcanization formulations.

Free-radical initiated curing techniques are valued when it is desirable to obtain cured articles that are substantially free of byproducts that include sulfur and/or metals. Although many commercially available elastomers are readily cured by currently available peroxide-initiated crosslinking techniques, poly(isobutylene-co-isoprene) is not (Loan, L. D. Pure Appl. Chem. 1972, 30, 173-180; Loan, L. D. Rubber Chem. Technol. 1967, 40, 149-176). Instead, under the action of organic peroxides, IIR suffers molecular weight losses by macro-radical fragmentation that are greater than any molecular weight gains obtained through macro-radical combination (Loan, L. D. J. Polym. Sci. Part A: Polym. Chem. 1964, 2, 2127-2134; Thomas, D. K. Trans. Faraday Soc. 1961, 57, 511-517).

In addition to failing to cure by peroxide-initiated crosslinking techniques, IIR also fails to cure appreciably under standard co-agent-based cure formulations, as evidenced by low yields observed for poly(isobutylene) grafting to acrylate, styrenic, and maleimide functionality (Kato, M. et al. J. Polym. Sci. Part A: Polym. Chem. 2006, 44, 1182-1188; Abbate, M. et al. J. Appl. Polym. Sci. 1995, 58, 1825-1837). IIR grades with isoprene content in excess of 4 mol % have been developed, that cure when mixed with significant quantities of peroxide (1 to 5 wt %) and co-agents such as N,N′-m-phenylenedimaleimide (2.5 wt %) (Asbroeck, E. V. et al., Canadian Patent No. 2,557,217 (2005). These high initiator and co-agent loadings resulted in expensive cure formulations, and vulcanizates that contained high levels of initiator-derived byproducts such as ketones and alcohols.

Oxely and Wilson used a cationic copolymerization of isobutylene and divinylbenzene to prepare an isobutylene-rich elastomer that responded positively to peroxide-initiated cross-linking (Oxely, C. E.; Wilson, G. J. Rubber Chem. Technol. 1969, 42, 1147-1154). However, the activation of both vinyl groups during the polymerization process yielded a product that contained a very high gel content, which impacted negatively on the material's processing characteristics.

Therefore, there exists a need for a halogen-free and metal-free isobutylene-rich polymer that cures efficiently without need for excessive free-radical initiation, and for articles made therefrom.

### SUMMARY OF THE INVENTION

A first aspect of the invention provides a functional macromonomer, which comprises a polymeric main chain comprising poly(isobutylene-co-isoprene) or poly(isobutylene-co-methylstyrene), and a plurality of side chains bonded to the main chain that comprise a substituted acrylate moiety, wherein at least one substituent of the substituted acrylate moiety comprises a functional moiety; and which is a polymer that homopolymerizes when initiated by a free-radical initiator.

In an embodiment of the first aspect, the structure of the functional macromonomer is

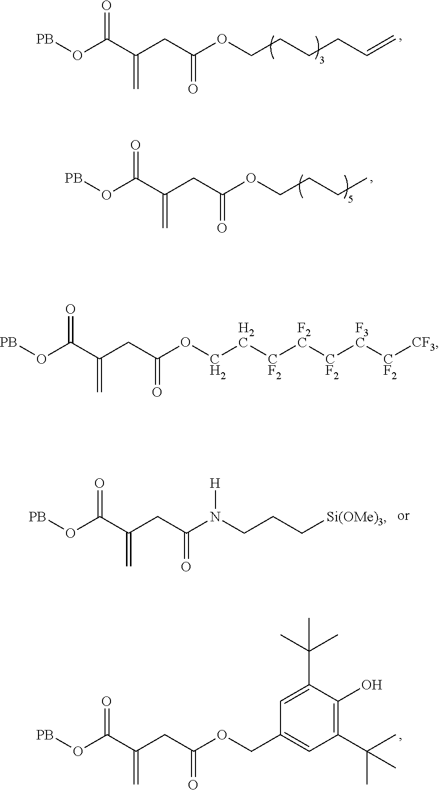

wherein respective moieties attached to PB represent one of a plurality of side chains and PB represents remaining portion of the macromonomer.

A second aspect of the invention provides a cross-linked polymer prepared by reacting the functional macromonomer of the first aspect with a free-radical initiator.

A third aspect of the invention provides an innerliner composition comprising cross-linked polymer of the second aspect.

In a fourth aspect, the invention provides a method of crosslinking halogenated isobutylene-rich elastomers, comprising subjecting to a free-radical initiator a mixture of (i) a cyclic anhydride, (ii) a functional nucleophile, (iii) a halogenated elastomer, and (iv) a base, and allowing reactions to occur such that crosslinking-bonds form and cross-linked product is obtained. In some embodiments of this aspect, the cyclic anhydride and the functional nucleophile are mixed together separately from mixing either of them with the halogenated elastomer and the base. Some embodiments of this aspect further comprise adding a co-agent to the mixture.

In a fifth aspect, the invention provides a kit comprising: functional macromonomer of the first aspect; optionally, a free-radical initiator; and instructions for use of the kit comprising directions to subject the macromonomer to free-radical initiation to form a cross-linked polymer.

In an embodiment of the fifth aspect the instructions comprise printed material, text or symbols provided on an electronic-readable medium, directions to an internet web site, or electronic mail.

In a sixth aspect, the invention provides a method for making a functional macromonomer comprising combining a mixture of a cyclic anhydride and a functional nucleophile, with a halogenated elastomer and a base. An embodiment of the sixth aspect further comprises combining a solvent for dissolving the halogenated elastomer. Certain embodiments of this aspect further comprise combining a phase transfer catalyst.

In some embodiments of the sixth aspect, the functional nucleophile is a compound of formula (10) or a compound of formula (11)

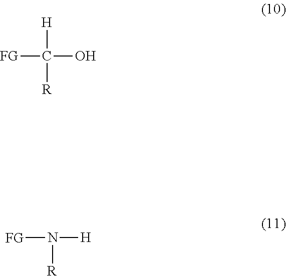

where R is hydrogen, a C₁₋₁₂ aliphatic group, or an aryl group; and FG is functional group comprising alkyl, aryl, phenyl, halogen, silane, alkoxysilane, phenolic, aryl alcohol, ether, thioether, aldehyde, ester, thioester, dithioester, carbonate, carbamate, amide, imide, nitrile, imine, enamine, olefin, vinyl, alkyne, phosphate, phosphonate, phosphonium, sulfate, sulfonate, sulfoxide, ammonium, imidazolium, pyridinium, thiazolium, nitroxyl, fluorinated aliphatic, perfluorinated aliphatic, imidazole, pyridine, thiazole, or a combination thereof. In some embodiments, aliphatic groups are alkyl groups.

In embodiments of this aspect, the halogenated elastomer is BIIR, CIIR, BIMS, or polychloroprene. In embodiments of this aspect, the base is Bu₄NOH, KOH, or NaOH. In embodiments of this aspect, the cyclic anhydride is itaconic anhydride or maleic anhydride. In embodiments of this aspect, the functional nucleophile is 9-decenol or perfluorooctanol. In further embodiments of this aspect, the functional nucleophile is perfluorooctanol. In certain embodiments of this aspect, the functional nucleophile is aminopropyltrimethoxysilane.

In embodiments of all of the above aspects, the cyclic anhydride comprises maleic anhydride, citraconic anhydride, phenyl maleic anhydride, or itaconic anhydride.

Embodiments of all of the above aspects further comprise one or more filler.

In embodiments of all of the above aspects, the free-radical initiator is: a chemical free-radical initiator, a photoinitiator, heat, heat in the presence of oxygen, thermo-mechanical means, electron bombardment, irradiation, high-shear mixing, photolysis (photo-initiation), ultraviolet light, electron beam radiation, radiation bombardment, electron bombardment, or a combination thereof.

In embodiments of all of the above aspects, the chemical free-radical initiator is an organic peroxide, a hydroperoxide, bicumene, dicumyl peroxide, di-t-butyl peroxide, an azo-based initiator, or homolysis of an organic peroxide.

In embodiments of all of the above aspects, the co-agent comprises maleimide, bis-maleimide, tris-maleimide, trimethylolpropane triacrylate, diallylisophthalate, N,N′-m-phenylenedimaleimide, N,N′-hexamethylenedimaleimide, zinc diacrylate, zinc dimethacylate, zinc di(dodecylitaconate), calcium di(decylitaconate), potassium decylitaconate, or a combination thereof.

### BRIEF DESCRIPTION OF THE DRAWINGS

For a better understanding of the invention and to show more clearly how it may be carried into effect, reference will now be made by way of example to the accompanying drawings, which illustrate aspects and features according to embodiments of the present invention, and in which:

FIG. 1 illustrates the dynamics of a DCP-initiated IIR cure formulation at 160° C.

FIG. 2 illustrates the dynamics of a DCP-initiated IIR-g-decyl maleate cure formulation at 160° C.

FIG. 3 illustrates the dynamics of a DCP-initiated IIR-g-decenyl itaconate cure formulation at 160° C.

FIG. 4 illustrates the dynamics of a DCP-initiated IIR-g-PEG itaconate cure formulation at 160° C.

FIG. 5 illustrates the dynamics of a DCP-initiated IIR-g-farnesyl maleate cure formulation at 160° C.

FIG. 6 illustrates the dynamics of DCP-initiated IIR-g-decyl phenylmaleate cure formulations at 160° C.

FIG. 7 illustrates the dynamics of a DCP-initiated IIR-g-1H,1H,2H,2H-perfluoro octyl itaconate cure formulation at 160° C.

FIG. 8 illustrates the dynamics of a DCP-initiated IIR-g-dodecyl itaconate cure formulations at 160° C.

FIG. 9 illustrates the dynamics of a DCP-initiated IMS-g-amidosilyl itaconate cure formulation in the absence of filler, and in the presence of 30 phr of precipitated silica, at 160° C.

FIG. 10 illustrates the dynamics of a DCP-initiated IIR-g-dodceyl itaconate cure formulation in the presence of zinc di(dodecyl itaconate), at 160° C.

FIG. 11 illustrates the dynamics of a DCP-initiated IIR-g-decenyl maleate cure formulation in the presence of N,N′-hexamethylenedimaleimide, at 160° C.

### DETAILED DESCRIPTION OF THE INVENTION

As discussed above, using previously known technology, it was not possible to cure butyl rubber using standard radical initiation techniques (e.g., using peroxides). As described herein, it has been discovered that performing a modification to butyl rubber allows the isobutylene-rich elastomers to cure efficiently when activated by free-radical initiator. Processes of the present invention introduce polymerizable functionality to IIR with no significant change in the number average molecular weight of the starting polymer.

Aspects of the present invention provide isobutylene-rich elastomers that are capable of being cured using free-radical initiation methods (known herein as “macromonomers”). Such macromonomers may additionally provide a moiety that fulfills a function other than crosslinking; such moieties are known herein as “functional moieties”. An example of a functional moiety is a moiety that binds silaceous fillers. Macromonomers bearing functional moieties are known herein as “functional macromonomers”. Other aspects of the present invention provide a process for making functional macromonomer. Further aspects of the invention provide a method of making crosslinked isobutylene-rich elastomers using standard free-radical crosslinking techniques. The following terms will be used in this description.

### DEFINITIONS

As used herein, the term “activating” means increasing the reaction rate of chemical reaction. Analogously, an “activator” is a species whose presence increases the chemical reaction rate of, in most cases herein, a free-radical polymerization reaction. As used herein, the term “activated C═C moiety” means a doubly bonded carbon-carbon moiety that is conjugated to an activator.

As used herein, “aliphatic” is intended to encompass saturated or unsaturated hydrocarbon moieties that are straight chain, branched or cyclic and, further, the aliphatic moiety may be substituted or unsubstituted.

As used herein, the term “IIR” means poly(isobutylene-co-isoprene), a synthetic elastomer commonly known as butyl rubber that typically has less than 4 mole % isoprene. As used herein, the term “BIIR” means brominated butyl rubber. As used herein, the term “CIIR” means chlorinated butyl rubber. As used herein, the term “BIMS” means brominated poly(isobutylene-co-para-methylstyrene).

As used herein, the term “conjugated” refers to covalently bonded atoms that influence each other to produce a region of electron delocalization where electrons do not belong to a single bond or atom, but rather to a group. Conjugation is possible when each contiguous atom in a chain possesses a p-orbital forming a pi bond. A first example of conjugation is a hydrocarbon chain with alternating single and multiple (e.g., double) bonds between the carbon atoms (e.g., C═C—C═C). A second example includes a hydrocarbon chain that includes heteroatoms with alternating single and multiple bonds (e.g., C═C—C═O).

As used herein, the terms “curing”, “vulcanizing”, or “cross-linking” refer to the formation of covalent bonds that link one polymer chain to another, thereby altering the physical properties of the material.

As used herein, the term “free-radical polymerizable” means able to polymerize when initiated by a free-radical initiator. As used herein, the term “free-radical curing” means crosslinking or curing that is initiated by free-radical initiators, which include chemical initiators, photoinitiators or radiation bombardment. As used herein, the term “free radical curing” means cross-linking that is initiated by a radical generating technique.

As used herein, the terms “functional group” and “FG” refers to a moiety comprising alkyl, aryl, phenyl, halogen, silane, alkoxysilane, phenolic, aryl alcohol, ether, thioether, aldehyde, ester, thioester, dithioester, carbonate, carbamate, amide, imide, nitrile, imine, enamine, olefin, vinyl, alkyne, phosphate, phosphonate, phosphonium, sulfate, sulfonate, sulfoxide, ammonium, imidazolium, pyridinium, thiazolium nitroxyl, fluorinated aliphatic, imidazole, pyridine, thiazole, or combinations thereof.

As used herein, the term “functional nucleophile” means a reagent bearing a functional group, defined above, and a nucleophilic moiety that is capable of ring-opening an anhydride.

As used herein, the term “macromonomer” means a polymer with pendant functional groups that are capable of polymerization under free-radical curing.

As used herein, the term “nucleophilic substitution” refers to a class of substitution reaction in which an electron-rich nucleophile bonds with or attacks a positive or partially positive charge of an atom attached to a leaving group. In certain examples herein, nucleophilic substitution refers to displacement of a halide from BIIR by a nucleophilic reagent and includes esterification.

As used herein, the term “pendant group” means a moiety that is attached to a polymer backbone.

As used herein, the term “polymer backbone” means the main chain of a polymer to which a pendant group is attached. For convenience below, PB is used to represent a portion of the macromonomer that includes polymer backbone and any pendant groups.

As used herein, the term “radical generating technique” means a method of creating free radicals, including the use of chemical initiators, photo-initiation, radiation bombardment, thermo-mechanical processes, oxidation reactions or other techniques known to those skilled in the art.

### DESCRIPTION

As discussed above, isobutylene-rich elastomers, which have a non-polar, aliphatic hydrocarbon structure, have poor peroxide-cure efficiencies, weak adhesion to dispersed fillers and solid surfaces, and little potential for enhancing physio-chemical properties such as oxidative stability. Surprisingly, it has been discovered that unsaturated, cyclic anhydrides can be used in conjunction with functional nucleophiles and a halogenated elastomer to yield functional isobutylene-rich elastomers. Such elastomers provide exceptional radical-curing activity and chemical reactivity that was lacking in other butyl rubber materials. As described herein, these new materials, hereafter called “functional macromonomers”, can be reinforced by a range of fillers and cross-linked extensively when exposed to small doses of a radical generating technique to give halogen-free thermosets that have only small amounts of initiator-derived byproducts. Moreover, the resulting vulcanizate contains substantially no residual unreacted functionality. This lack of residual unreacted functionality is advantageous since such residue if present in substantial quantity would lead to chemical and physical instability.

An aspect of the present invention provides a method for preparing a functional macromonomer comprising reactions of (i) a cyclic anhydride, (ii) a functional nucleophile, (iii) a halogenated elastomer, and (iv) a base. In some embodiments a solvent is also present. Examples of these reactants are described below followed by a description of the method of preparing a functional macromonomer.

### (i) Cyclic Anhydride

In one embodiment of this aspect, the cyclic anhydride has an endo-C═C bond.

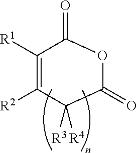

where R¹, R², R³, R⁴ are hydrogen, C₁₋₁₂ aliphatic group, aryl group, or combinations thereof. In some embodiments, n is 0 to 4. In certain embodiments, n is 0 to 3. In an embodiment, n is 0. Non-limiting examples include maleic anhydride, citraconic anhydride and phenylmaleic anhydride, whose structures are illustrated below.

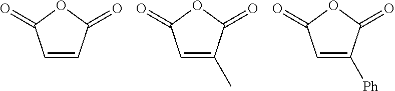

In an embodiment, the cyclic anhydride is maleic anhydride.

In another embodiment, the cyclic anhydride has an exo-C═C bond.

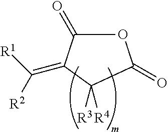

where R¹, R², R³, R⁴ are hydrogen, C₁₋₁₂ aliphatic, aryl, or a combination thereof. In some embodiments, m is 1 to 4. In certain embodiments, m is 1 to 3. In an embodiment, m is 1. In an embodiment, the cyclic anhydride is itaconic anhydride, whose structure is illustrated below.

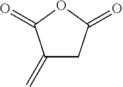

It is possible to utilize mixtures of the various types of cyclic anhydrides described hereinabove.

### (ii) Functional Nucleophile

In an embodiment, the functional nucleophile is an alcohol,

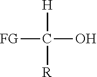

where R is selected from a group including hydrogen, C₁₋₁₂ aliphatic group, and an aryl group. FG represents a substituent that comprises a functional moiety. The functionality moiety is not particularly restricted, and is within the purview of those skilled in the art. Non-limiting examples of functionality moieties are alkyl, aryl, phenyl, halogen, silane, alkoxysilane, phenolic, aryl alcohol, ether, thioether, aldehyde, ester, thioester, dithioester, carbonate, carbamate, amide, imide, nitrile, imine, enamine, olefin, vinyl, alkyne, phosphate, phosphonate, phosphonium, sulfate, sulfonate, sulfoxide, ammonium, imidazolium, pyridinium, thiazolium nitroxyl, fluorinated aliphatic, imidazole, pyridine, thiazole, and combinations thereof. Non-limiting examples of functional moieties are 9-decenol and farnesol.

In one embodiment, the functional nucleophile is an amine,

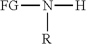

where R is hydrogen, C₁₋₁₂ aliphatic, or aryl. FG is as defined hereinabove. Non-limiting examples of FG include aminopropyl trimethoxysilane and hexadecylamine. It is possible to utilize mixtures of the various types of functional nucleophiles described hereinabove.
(iii) Halogenated Elastomer

A suitable halogenated elastomer comprises non-electrophilic mers, and halogen-comprising electrophiles that react with carboxylate nucleophiles. After nucleophilic substitution of halogen by carboxylate, the elastomer becomes the polymer backbone of the functional macromonomer.

The composition of non-electrophilic mers within a halogenated elastomer is not particularly restricted, and may be made up of any polymerized olefin monomer. As used throughout this specification, the term “olefin monomer” is intended to have a broad meaning and encompasses α-olefin monomers, diolefin monomers and polymerizable monomers containing at least one olefin group.

In a preferred embodiment, the olefin monomer is an α-olefin monomer. α-Olefin monomers are well known in the art and the choice thereof for use in the present process is within the purview of a person skilled in the art. In some embodiments, the α-olefin monomer is isobutylene, ethylene, propylene, 1-butene, 1-pentene, 1-hexene, 1-octene, branched isomers thereof, styrene, α-methylstyrene, para-methylstyrene or mixtures thereof. In certain embodiments, α-olefin monomers are isobutylene and para-methylstyrene.

In yet another embodiment, the olefin monomer comprises a diolefin monomer. Diolefin monomers are well known in the art and the choice thereof for use in the present process is within the purview of a person skilled in the art. Non limiting examples of suitable diolefin monomers include 1,3-butadiene, isoprene, divinyl benzene, 2-chloro-1,3-butadiene, 2,3-dimethyl-1,3-butadiene, 2-ethyl-1,3-butadiene, piperylene, myrcene, allene, 1,2-butadiene, 1,4,9-decatriene, 1,4-hexadiene, 1,6-octadiene, 1,5-hexadiene, 4-methyl-1,4-hexadiene, 5-methyl-1,4-hexadiene, 7-methyl-1,6-octadiene, phenylbutadiene, pentadiene or mixtures thereof. In another embodiment, the diolefin monomer is an alicyclic compound. Non-limiting examples of suitable alicyclic compounds include norbornadiene, aliphatic derivatives thereof, 5-alkylidene-2-norbornene compounds, 5-alkenyl-2-norbornene compounds and mixtures thereof, such as 5-methylene-2-norbornene, 5-ethylidene-2-norbornene, 5-propenyl-2-norbornene and mixtures thereof. Further non-limiting examples of suitable alicyclic compounds include 1,4-cyclohexadiene, 1,5-cyclooctadiene, 1,5-cyclododecadiene, methyltetrahydroindene, dicyclopentadiene, bicyclo [2.2.1]hepta-2,5-diene and mixtures thereof. In certain embodiments, diolefin monomers are isoprene and 2-chloro-1,3-butadiene.

It is possible to utilize mixtures of the various types of olefin monomers described hereinabove.

In an embodiment, the olefin is a mixture of isobutylene (as described hereinabove) and at least one diolefin monomer (as described hereinabove). In a certain embodiment, such a monomer mixture is made up of isobutylene and isoprene. In this embodiment, a mole percent of the diolefin monomer is from about 0.5 to about 3. In certain embodiments, from about 1 to about 2 mole percent of the diolefin monomer is incorporated into the mixture of isobutylene and isoprene.

In an embodiment, the olefin is a mixture of isobutylene (as described hereinabove) and at least one α-olefin (as described hereinabove). An example of such a monomer mixture is made up of isobutylene and para-methylstyrene. In this embodiment, the mixture of isobutylene and para-methylstyrene is from about 0.5 to about 3 mole percent para-methylstyrene. In certain embodiments, the mixture is about 1 to about 2 mole percent of para-methylstyrene.

The number of halogen-containing electrophilic groups per polymer chain will affect the extent of cross-linking that can be achieved by reaction with a latent curative. Typically, the electrophile content of a halogenated elastomer is from about 0.1 to about 100 groups per 1000 polymer backbone carbons. In certain embodiments, the electrophile content is between 5 and 50 groups per 1000 polymer backbone carbons.

The selection of a halogen-containing electrophile is within the purview of a person skilled in the art, and can be made from alkyl halide, allylic halide and benzylic halide, or mixtures thereof. Non-limiting, generic examples are illustrated below.

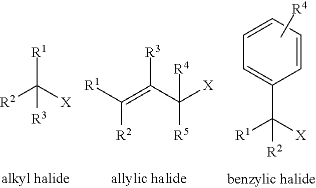

In some embodiments, the halogenated elastomer is made up of a random distribution of isobutylene mers, isoprene mers and allylic halide electrophiles

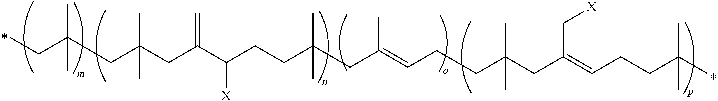

where X is selected from the group including bromine and chlorine, and mixtures thereof. Elastomers made up of about 97 mole % isobutylene, 1 mole % isoprene, and 2 mole % allylic halide are commonly known as halogenated butyl rubber.

In certain embodiments, the halogenated elastomer is made up of a random distribution of isobutylene mers, para-methylstyrene mers and a benzylic halide electrophile

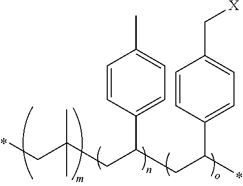

where X is selected from the group including bromine and chlorine, and mixtures thereof. Elastomers made up of about 97 mole % isobutylene, 1 mole % para-methylstyrene, and 2 mole % benzylic bromide are commonly known as BIMS.

In an embodiment, the halogenated elastomer is made up of a random distribution of 2-chloro-1,3-butadiene mers and an allylic chloride electrophile.

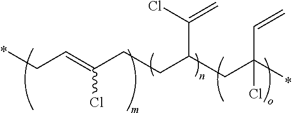

This elastomer is commonly known as polychloroprene.

In a further embodiment, the halogenated elastomer is made up of a random distribution of ethylene mers, propylene mers and allylic halide electrophiles derived from halogenated ethylidene norbornadiene mers.

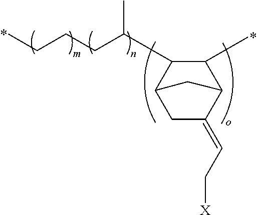

This elastomer is commonly known as halogenated EPDM.

In an embodiment, the halogenated polymer is made up of a random distribution of ethylene mers, propylene mers and halogenated alkyl halide electrophiles. This includes halogenated ethylene-propylene copolymers, halogenated polyethylene, and halogenate polypropylene.

In some embodiments, the halogenated elastomers used in the present invention have a molecular weight (Mn) in the range from about 10,000 to about 500,000. In certain embodiments, Mn is about 10,000 to about 200,000. In certain other embodiments, Mn is about 60,000 to about 150,000. In still other embodiments, Mn is about 30,000 to about 100,000. It will be understood by those of skill in the art that reference to molecular weight refers to a population of polymer molecules and not necessarily to a single or particular polymer molecule.

### (iv) Base

The base is not particularly restricted, and can be any inorganic or organic base that is capable of deprotonating a carboxylic acid to generate a carbolate anion. In an embodiment, the base is a tetraalkylammonium hydroxide (R₄N⁺HO⁻), a non-limiting example of which includes Bu₄NOH. In another embodiment, the base is an alkali metal hydroxide; non-limiting examples include KOH, and NaOH. It is also possible to use a combination of bases.

### Method of Preparing Functional Macromonomer

As described hereinabove, a method of the present invention comprises mixing in any order (i) a cyclic anhydride, (ii) a functional nucleophile, (iii) a halogenated elastomer, and (iv) a base. Mixing of these reagents may be done under solvent-free conditions, or using a solvent that dissolves the halogenated elastomer. Non-limiting examples of suitable solvents include toluene, hexane, tetrahydrofuran, xylene and combinations thereof.

In one embodiment, a cyclic anhydride and a functional nucleophile are mixed to yield an intermediate carboxylic acid. This intermediate is subsequently contacted with a halogenated elastomer and a base to form the functional macromonomer. Those with skill in the art will identify the second reaction as an esterification. In the following non-limiting example, maleic anhydride (a cyclic anhydride) is reacted with aminopropyltrimethoxysilane (a functional nucleophile) in toluene (solvent) to form an acid-amide intermediate, which is subsequently reacted with BIIR (halogenated elastomer) and Bu₄NOH (base) to produce a functional macromonomer comprising pendant —OCO—C═C—COO— moieties (polymerizable C═C moieties) and trialkoxysilane groups (functional moieties).

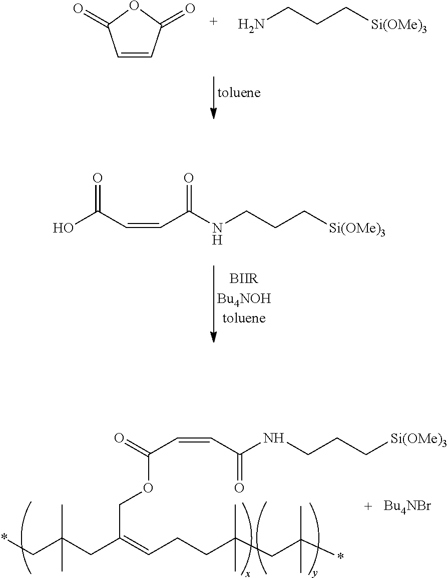

In the following non-limiting example, itaconic anhydride and dodecanol are reacted to yield an acid-ester intermediate, and hydroxy-TEMPO is reacted with itaconic anhydride to form a second acid-ester intermediate. These two acid-ester intermediates are mixed with brominated EPDM and KOH in the presence of a catalytic amount of phase transfer catalyst Bu₄NBr to produce a functional macromonomer bearing pendant CH₂═CR¹—COOR² moieties and a mixture of dodecyl and nitroxyl functionalities.

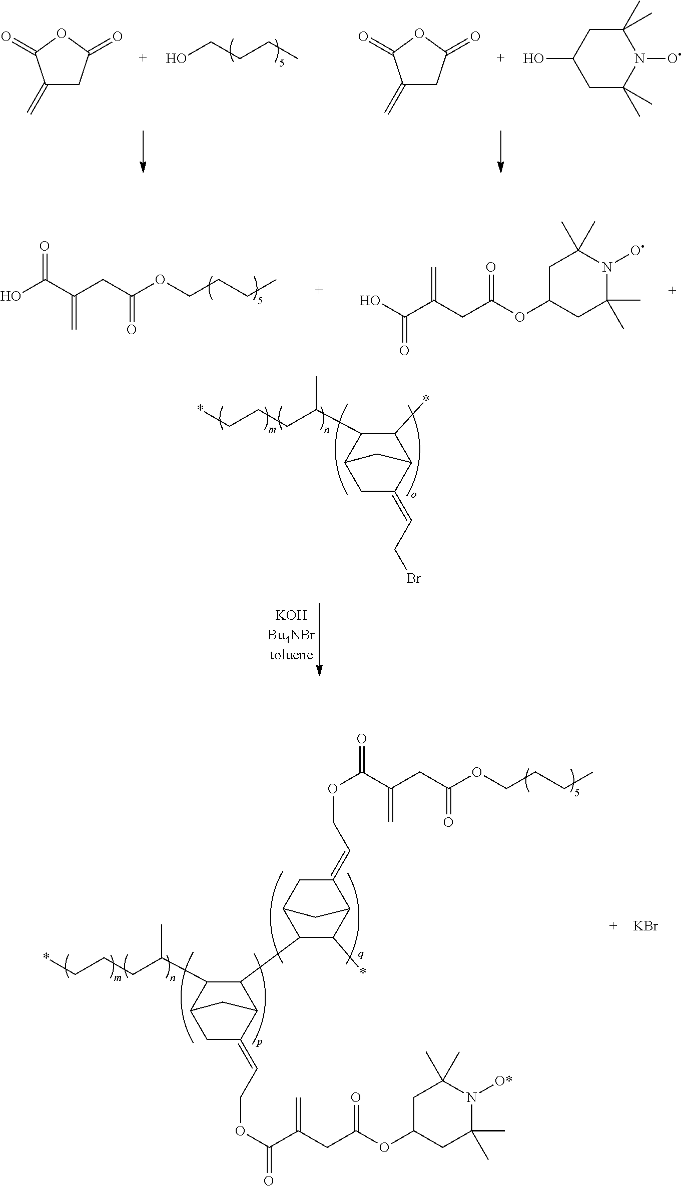

In another embodiment, a cyclic anhydride, a functional nucleophile, a halogenated elastomer and a base are mixed simultaneously to prepare the functional macromonomer. In the following non-limiting example, itaconic anhydride, 9-decenol, BIMS, and KOH in the presence of a catalytic amount of phase transfer catalyst Bu₄NBr are mixed to produce a functional macromonomer containing pendant CH₂═CR¹—COOR² bonds and terminal vinyl functional groups.

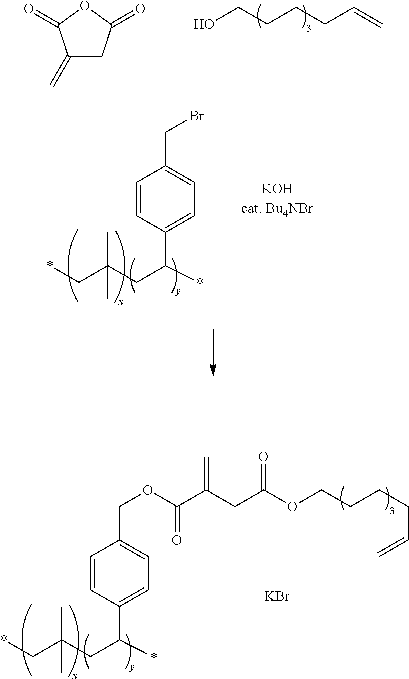

In cases where treatment of the carboxylic acid with base yields a carboxylate salt that is non-nucleophililc and/or insoluble in the reaction medium, it may be desirable to use a phase transfer catalyst to promote esterification. Typically, phase transfer catalysis involves the introduction of catalytic amounts of a phase transfer catalyst, such as a tetraalkylammonium halide, a polyether, or a crown ether. Phase transfer catalysts suitable for use in the present invention can be any phase transfer catalyst known to one skilled in the art. Phase transfer catalysts are described in Monographs in Modern Chemistry No 11: Phase Transfer Catalysis, 2^{nd} ed.; Verlag Chimie: Germany, 1983. Non-limiting examples of phase transfer catalysts include tetrabutylammonium bromide, trioctylmethylammonium chloride, 18-crown-6, and mixtures thereof.

Optionally, a co-agent may be added to a solvated or unsolvated mixture of (i) a cyclic anhydride, (ii) a functional nucleophile, (iii) a halogenated elastomer, and (iv) a base prior to subjecting the mixture to a free-radical initiator. Such co-agent can increase the reactivity. Non-limiting examples of co-agents include maleimide, bis-maleimide, tris-maleimide, trimethylolpropane triacrylate, diallylisophthalate, N,N′-m-phenylenedimaleimide, N,N′-hexamethylenedimaleimide, zinc diacrylate, zinc dimethacylate, zinc di(dodecylitaconate), calcium di(decylitaconate), potassium decylitaconate, or combinations thereof.

An aspect of the present invention includes a functional macromonomer. In one embodiment, the functional macromonomer comprises a polymer backbone and pendant group with the following structure

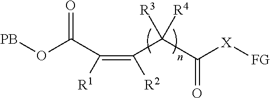

where PB is a remaining portion of the macromonomer, R¹, R², R³, R⁴ are selected from hydrogen, an aliphatic group containing 1 to about 12 carbons, an aryl group or mixtures thereof. The variable n can range from 0 to 5. In some embodiments, n is from 0 to 3. In certain embodiments, n is 0. X is oxygen, N—H, or N—R where R is an aliphatic group containing 1 to about 12 carbons, and an aryl group. The functionality within the group FG, defined hereinabove, is not particularly restricted, and is in the purview of those skilled in the art. Specific examples of functionality that can be contained within the group FG are alkyl, aryl, phenyl, halogen, silane, alkoxysilane, phenolic, aryl alcohol, ether, thioether, aldhehyde, ester, thioester, dithioester, carbonate, carbamate, amide, imide, nitrile, imine, enamine, olefin, vinyl, alkyne, phosphate, phosphonate, phosphonium, sulfate, sulfonate, sulfoxide, ammonium, imidazolium, pyridinium, thiazolium, nitroxyl, fluorinated aliphatic, imidazole, pyridine, thiazole, and mixtures thereof.

In another embodiment, the functional macromonomer comprises a polymer backbone and pendant group with the following structure:

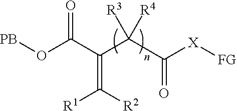

where PB is a remaining portion of the macromonomer, R¹, R², R³, R⁴ are hydrogen, an aliphatic group containing 1 to about 12 carbons, an aryl group or mixtures thereof. The variable n is 1 to 5. In certain embodiments, n is 1 to 3. In certain embodiments, n is 1. X is oxygen, N—H, or N—R where R is an aliphatic group containing 1 to about 12 carbons, or an aryl group. The functionality within the group FG, defined hereinabove, is not particularly restricted, and is in the purview of those skilled in the art. Non-limiting examples of functionality that can be within the group FG are alkyl, aryl, phenyl, halogen, silane, alkoxysilane, phenolic, aryl alcohol, ether, thioether, aldhehyde, ester, thioester, dithioester, carbonate, carbamate, amide, imide, nitrile, imine, enamine, olefin, vinyl, alkyne, phosphate, phosphonate, phosphonium, sulfate, sulfonate, sulfoxide, ammonium, imidazolium, pyridinium, thiazolium, nitroxyl, fluorinated aliphatic, imidazole, pyridine, thiazole, or mixtures thereof.

IIR adheres weakly to solid surfaces and standard reinforcing fillers such as silica, since it is made up of non-polar monomers. As a result, it is difficult to disperse high surface energy siliceous fillers within IIR, necessitating polymer-filler compatibilization strategies to produce composite articles that meet material property requirements. One approach to overcome this deficiency is to prepare functional polymer derivatives containing ionic, polar or associating groups that interact strongly with siliceous fillers, or to introduce alkoxysilane functionality that reacts to provide a covalent bond between the polymer and filler.

A functional macromonomer described hereinabove can contain one or more fillers such as carbon black, precipitated silica, clay, glass fibres, polymeric fibres and finely divided minerals. These additives are typically used to improve the physical properties of polymers. Typically, the amount of filler is between about 10 wt % and about 60 wt %. In certain embodiments, filler content is between about 25 wt % and about 45 wt %.

A functional macromonomer described hereinabove can contain one or more nano-scale fillers such as exfoliated clay platelets, sub-micron particles of carbon black, and sub-micron particles of mineral fillers such as silica. These nano-scale additives are typically used to improve the physical properties of polymers. Typically, the amount of nano-scale filler is between about 0.5 wt % and about 30 wt %. In certain embodiments, nano-scale filler content is between about 2 wt % and about 10 wt %.

A functional macromonomer described hereinabove can comprise one or more coagents for improving crosslinking performance. Non-limiting examples of co-agents include maleimide, bis-maleimide, tris-maleimide, trimethylolpropane triacrylate, diallylisophthalate, N,N′-m-phenylenedimaleimide, N,N′-hexamethylenedimaleimide, zinc diacrylate, zinc dimethacylate, zinc di(dodecylitaconate), calcium di(decylitaconate), potassium decylitaconate, or combinations thereof.

An aspect of the present invention provides a method of preparing a cross-linked polymer by subjecting a functional macromonomer to a free-radical generating technique. Free-radicals may, for example, be generated through the use of ultraviolet light, a chemical initiator (such as a peroxide), thermo-mechanical means, radiation, electron bombardment or the like. See any of the following references for a general discussion on radical generation techniques: Moad, G. Prog. Polym. Sci. 1999, 24, 81-142; Russell, K. E. Prog. Polym. Sci. 2002, 27, 1007-1038; and Lazar, M., Adv. Polym. Sci. 1989, 5, 149-223. Non-limiting examples of free-radical initiators include: a chemical free-radical initiator, a photoinitiator, heat, heat in the presence of oxygen, thermo-mechanical means, electron bombardment, irradiation, high-shear mixing, photolysis (photo-initiation), ultraviolet light, electron beam radiation, radiation bombardment, electron bombardment, and combinations thereof. Examples of chemical free-radical initiators include organic peroxide, hydroperoxide, bicumene, dicumyl peroxide, di-t-butyl peroxide, azo-based initiator, and homolysis of an organic peroxide. When an organic peroxide is used, the organic peroxide is generally present in an amount between about 0.005 wt % and about 5.0 wt %. In certain embodiments organic peroxide is present in an amount between about 0.05 wt % and about 1.0 wt %.

Another aspect of the present invention is a cross-linked product of the functional macromonomer described hereinabove. These cross-linked products are expected to have superior qualities such as good thermo-oxidative stability, exceptional compression set resistance, high modulus, and excellent gas impermeability. Accordingly, articles made from such cross-linked polymers, such as, for example, tire inner liners, gaskets, and sealants, can exploit these qualities without the presence of halogen and/or metal byproducts, or extractable peroxide initiator decomposition products.

Embodiments of the present invention will be described with reference to the following Examples, which are provided for illustrative purposes only and should not be used to limit or construe the scope of the invention.

### WORKING EXAMPLES

### Materials and Methods

Poly(isobutylene-co-isoprene)(isoprene content of 2.82 mol %) and brominated poly(isobutylene-co-isoprene) (BIIR) containing 0.15 mmol/g of allylic bromide was used as received from Lanxess Inc. (Sarnia, ON, USA). Brominated poly(isobutylene-co-methylstyrene) (benzylic bromide content 0.21 mmol/g) was used as manufactured by Exxon Mobil (Houston, Tex., USA). The following reagents were used as received from Sigma-Aldrich (Oakville, ON, Canada) maleic anhydride (99%), itaconic anhydride (95%), phenylmaleic anhydride (99%), tetrabutylammonium hydroxide (1 M in methanol), tetrabutylammonium bromide (98%), dodecanol (90%), 3-aminopropyl triethoxy silane (98%), 1H,1H,2H,2H-perfluoro-1-octanol (97%), farnesol (95%), 9-decen-1-ol (90%), polyethyleneglycol monomethylether (M_{w}=750), dicumyl peroxide (“DCP”) (98%), N,N′-m-phenylene dimaleimide (99%). Precipitated silica (HiSil 233) was used as received from PPG (Pittsburgh, Pa., USA).

¹H NMR spectra were acquired in CDCl₃ on a Bruker Avance-400 spectrometer (available from Bruker, Milton, ON, Canada). The extent of crosslinking as a function of time was monitored through measurements of dynamic shear modulus (G′) using an Alpha Technologies, Advanced Polymer Analyzer 2000 (Akron, Ohio, USA) operating at an oscillation frequency of 1 Hz and an arc of 3°.

### Example 1

### Comparative Example

### Butyl Rubber

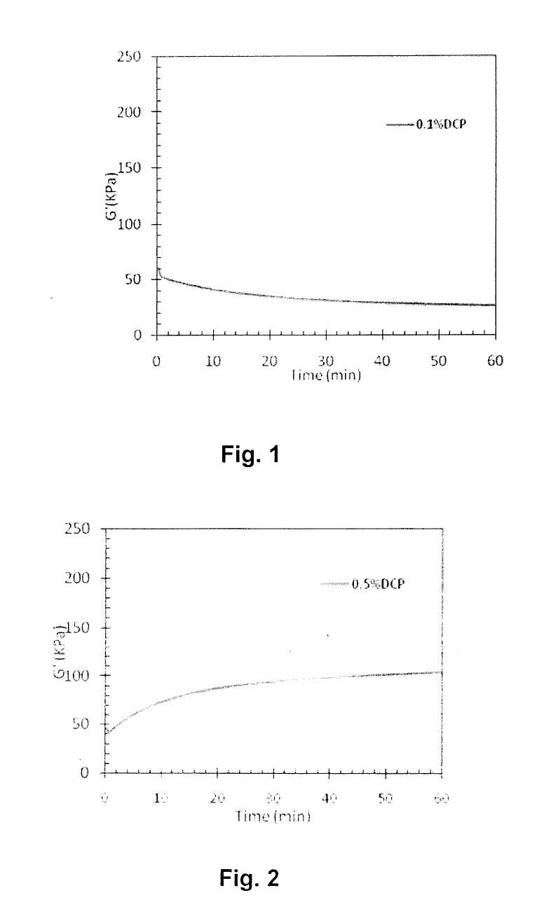

IIR (5 g) was coated with DCP (0.092 mmol, 0.025 g) in 1-5 mL of acetone (0.092 mmol, 0.025 g DCP) and allowed to dry before passing the sample 5 times through a 2-roll mill. Evidence of polymer degradation was obtained by rheometry data that is presented in FIG. 1.

### Example 2

### Synthesis and Curing of IIR-g-Dodecyl Maleate

Dodecanol (6.7 mmol, 1.24 g), maleic anhydride (8.04 mmol, 0.8 g), were dissolved in toluene (10 g) and heated to 80° C. for 4 hr. Residual starting materials and solvent were removed by Kugelrohr distillation (T=80° C., P=0.6 mmHg). The resulting acid-ester (0.93 g, 3.3 mmol) was treated with a 1 M solution of Bu₄NOH in methanol (3.3 mL, 3.3 mmol Bu₄NOH) to yield the desired Bu₄Ncarboxylate salt, which was isolated by removing methanol under vacuum.

BIIR (11 g) and Bu₄NBr (0.53 g, 1.65 mmol) were dissolved in toluene (100 g) and heated to 85° C. for 180 min. Bu₄Ncarboxylate salt (1.73 g, 3.3 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-dodecyl maleate.

IIR-g-dodecyl maleate (5 g) was coated with DCP (0.092 mmol, 0.025 g) in 1-5 mL of acetone (0.092 mmol, 0.025 g DCP) and allowed to dry before passing the sample 5 times through a 2-roll mill. Evidence of substantial curing was obtained by rheometry data that is presented in FIG. 2.

### Example 3

### Synthesis and Curing of IIR-g-9-Decenyl Itaconate

9-Decen-1-ol (13.3 mmol, 2.08 g), itaconic anhydride (16.6 mmol, 1.86 g), were dissolved in toluene (10 g) and heated to 80° C. for 4 hr. Residual starting materials and solvent were removed by Kugelrohr distillation (T=80° C., P=0.6 mmHg). The resulting acid-ester (0.88 g, 3.3 mmol) was treated with a 1 M solution of Bu₄NOH in methanol (3.3 mL, 3.3 mmol Bu₄NOH) to yield the desired Bu₄Ncarboxylate salt, which was isolated by removing methanol under vacuum.

BIIR (11 g) and Bu₄NBr (0.53 g, 1.65 mmol) were dissolved in toluene (100 g) and heated to 85° C. for 180 min. Bu₄Ncarboxylate salt (1.68 g, 3.3 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-9-decenylitaconate.

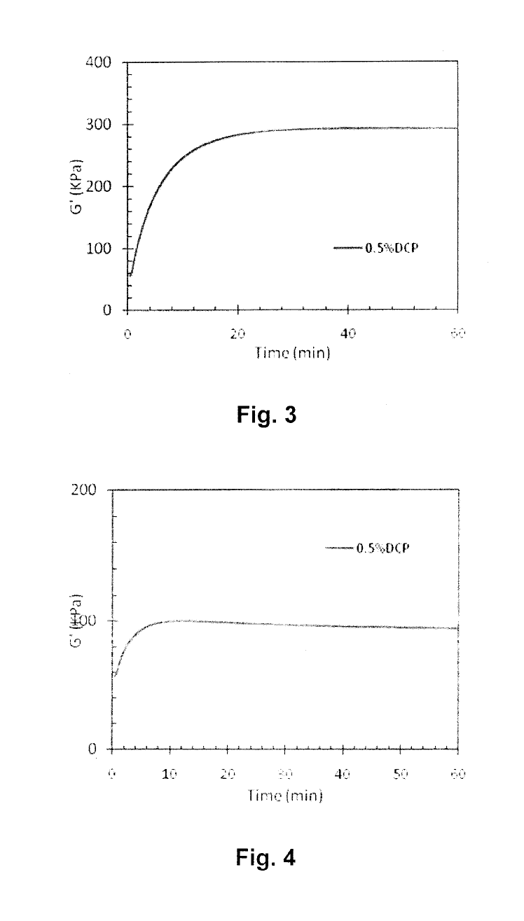

IIR-g-9-decenylitaconate (5 g) was coated with DCP (0.092 mmol, 0.025 g) in 1-5 mL of acetone (0.092 mmol, 0.025 g DCP) and allowed to dry before passing the sample 5 times through a 2-roll mill. Evidence of substantial curing was obtained by rheometry data that is presented in FIG. 3.

### Example 4

### Synthesis and Curing of IIR-g-PEG Itaconate

Polyethyleneglycol monomethylether (34 mmol, 18.1 g), itaconic anhydride (37.0 mmol, 3.0 g), were dissolved in toluene (10 g) and heated to 80° C. for 4 hr. Residual starting materials and solvent were removed by Kugelrohr distillation (T=80° C., P=0.6 mmHg). The resulting acid-ester (2.84 g, 3.3 mmol) was treated with a 1 M solution of Bu₄NOH in methanol (3.3 mL, 3.3 mmol Bu₄NOH) to yield the desired Bu₄Ncarboxylate salt, which was isolated by removing methanol under vacuum.

BIIR (11 g) and Bu₄NBr (0.53 g, 1.65 mmol) were dissolved in toluene (100 g) and heated to 85° C. for 180 min. Bu₄Ncarboxylate salt (3.64 g, 3.3 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-PEG itaconate.

IIR-g-PEG itaconate (5 g) was coated with DCP (0.092 mmol, 0.025 g) in 1-5 mL of acetone (0.092 mmol, 0.025 g DCP) and allowed to dry before passing the sample 5 times through a 2-roll mill. Evidence of substantial curing was obtained by rheometry data that is presented in FIG. 4.

### Example 5

### Synthesis and Curing of IIR-g-Farnesyl Maleate

Farnesol (6.7 mmol, 1.5 g), maleic anhydride (8.04 mmol, 0.8 g), were dissolved in toluene (10 g) and heated to 80° C. for 4 hr. Residual starting materials and solvent were removed by Kugelrohr distillation (T=80° C., P=0.6 mmHg). The resulting acid-ester (1.05 g, 3.3 mmol) was treated with a 1 M solution of Bu₄NOH in methanol (3.3 mL, 3.3 mmol Bu₄NOH) to yield the desired Bu₄Ncarboxylate salt, which was isolated by removing methanol under vacuum.

BIIR (11 g) and Bu₄NBr (0.53 g, 1.65 mmol) were dissolved in toluene (100 g) and heated to 85° C. for 180 min. Bu₄Ncarboxylate salt (1.85 g, 3.3 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-farnesyl maleate.

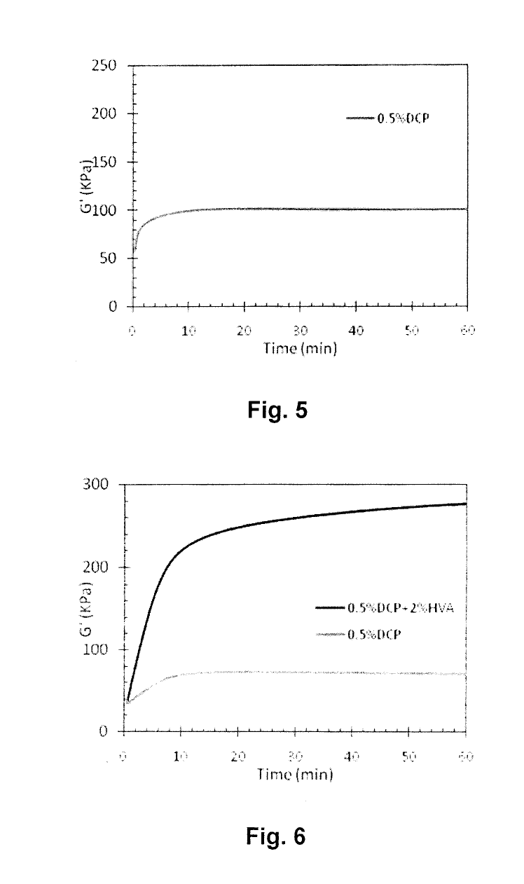

IIR-g-farnesyl maleate (5 g) was coated with DCP (0.092 mmol, 0.025 g) in 1-5 mL of acetone (0.092 mmol, 0.025 g DCP) and allowed to dry before passing the sample 5 times through a 2-roll mill. Evidence of substantial curing was obtained by rheometry data that is presented in FIG. 5.

### Example 6

### Synthesis and Curing of IIR-g-Dodecyl Phenylmaleate

Dodecanol (8.3 mmol, 1.56 g), phenylmaleic anhydride (9.2 mmol, 1.45 g), were dissolved in toluene (10 g) and heated to 80° C. for 4 hr. Residual starting materials and solvent were removed by Kugelrohr distillation (T=80° C., P=0.6 mmHg). The resulting acid-ester (1.13 g, 3.3 mmol) was treated with a 1 M solution of Bu₄NOH in methanol (3.3 mL, 3.3 mmol Bu₄NOH) to yield the desired Bu₄Ncarboxylate salt, which was isolated by removing methanol under vacuum.

BIIR (11 g) and Bu₄NBr (0.53 g, 1.65 mmol) were dissolved in toluene (100 g) and heated to 85° C. for 180 min. Bu₄Ncarboxylate salt (1.92 g, 3.3 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-dodecyl phenylmaleate.

IIR-g-dodecyl phenylmaleate (5 g) was coated with DCP (0.092 mmol, 0.025 g) in 1-5 mL of acetone (0.092 mmol, 0.025 g DCP) and allowed to dry before passing the sample 5 times through a 2-roll mill. A second cure formulation containing HVA2 (0.1 g, 0.37 mmol) was mill-mixed into the co-coagent cured samples by repeated passing through the nip of a 2-roll mill. The rheometry data presented in FIG. 6 show evidence of substantial curing in the absence of HVA2 coagent, and a substantial increase in the extent of cure in a formulation containing HVA2.

### Example 7

### Synthesis and Curing of IIR-g-1H,1H,2H,2H-perfluorooctyl itaconate

1H,1H,2H,2H-Perfluoro-1-octanol (4.58 mmol, 1.66 g), itaconic anhydride (5.03 mmol, 0.56 g), were dissolved in toluene (10 g) and heated to 80° C. for 4 hr. Residual starting materials and solvent were removed by Kugelrohr distillation (T=80° C., P=0.6 mmHg). The resulting acid-ester (1.57 g, 3.3 mmol) was treated with a 1 M solution of Bu₄NOH in methanol (3.3 mL, 3.3 mmol Bu₄NOH) to yield the desired Bu₄Ncarboxylate salt, which was isolated by removing methanol under vacuum.

BIIR (11 g) and Bu₄NBr (0.53 g, 1.65 mmol) were dissolved in toluene (100 g) and heated to 85° C. for 180 min. Bu₄Ncarboxylate salt (2.366 g, 3.3 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-1H,1H,2H,2H-perfluorooctyl itaconate.

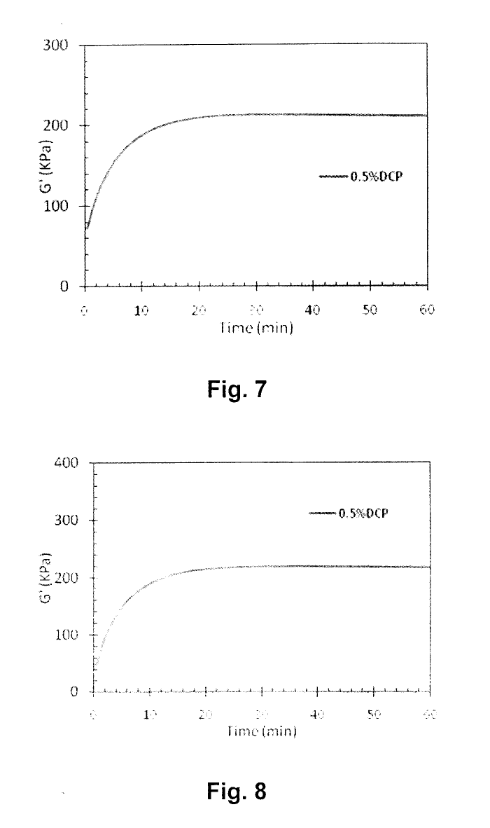

IIR-g-1H,1H,2H,2H-perfluorooctyl itaconate (5 g) was coated with DCP (0.092 mmol, 0.025 g) in 1-5 mL of acetone (0.092 mmol, 0.025 g DCP) and allowed to dry before passing the sample 5 times through a 2-roll mill. Evidence of substantial curing was obtained by rheometry data that is presented in FIG. 7.

### Example 8

### Filled IIR-g-Dodecyl Itaconate

Dodecanol (8.0 mmol, 1.5 g), itaconic anhydride (24 mmol, 2.7 g), were dissolved in toluene (10 g) and heated to 80° C. for 4 hr. Residual starting materials and solvent were removed by Kugelrohr distillation (T=80° C., P=0.6 mmHg). The resulting acid-ester (0.98 g, 3.3 mmol) was treated with a 1 M solution of Bu₄NOH in methanol (3.3 mL, 3.3 mmol Bu₄NOH) to yield the desired Bu₄Ncarboxylate salt, which was isolated by removing methanol under vacuum.

BIIR (11 g) and Bu₄NBr (0.53 g, 1.65 mmol) were dissolved in toluene (100 g) and heated to 85° C. for 180 min. Bu₄Ncarboxylate salt (1.78 g, 3.3 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-dodecyl itaconate.

IIR-g-dodecyl itaconate (5 g) was coated with DCP (0.092 mmol, 0.025 g) in 1-5 mL of acetone (0.092 mmol, 0.025 g DCP) and allowed to dry before passing the sample 5 times through a 2-roll mill. Evidence of substantial curing was obtained by rheometry data that is presented in FIG. 8.

### Example 9

### Synthesis and Curing of IMS-g-Aminosilane Itaconate

3-Aminopropyl triethoxysilane (5.9 mmol, 1.32 g), itaconic anhydride (5.9 mmol, 0.67 g) were dissolved in toluene (10 g) and stirred at room temperature for 1 hr. Residual starting materials and solvent were removed by Kugelrohr distillation (T=50° C., P=0.6 mmHg). The resulting acid-ester (1.53 g, 4.6 mmol) was treated with a 1 M solution of Bu₄NOH in methanol (4.6 mL, 4.6 mmol Bu₄NOH) to yield the desired Bu₄Ncarboxylate salt, which was isolated by removing methanol under vacuum. BIMS (11 g) was dissolved in toluene (100 g). Bu₄Ncarboxylate salt (2.64 g, 4.6 mmol) was added before heating the reaction mixture to 85° C. for 120 min under N₂ atmosphere. The esterification product was isolated by precipitation from excess acetone, purified by dissolution/precipitation using hexanes/acetone, and dried under vacuum, yielding IMS-g-amidosilyl itaconate.

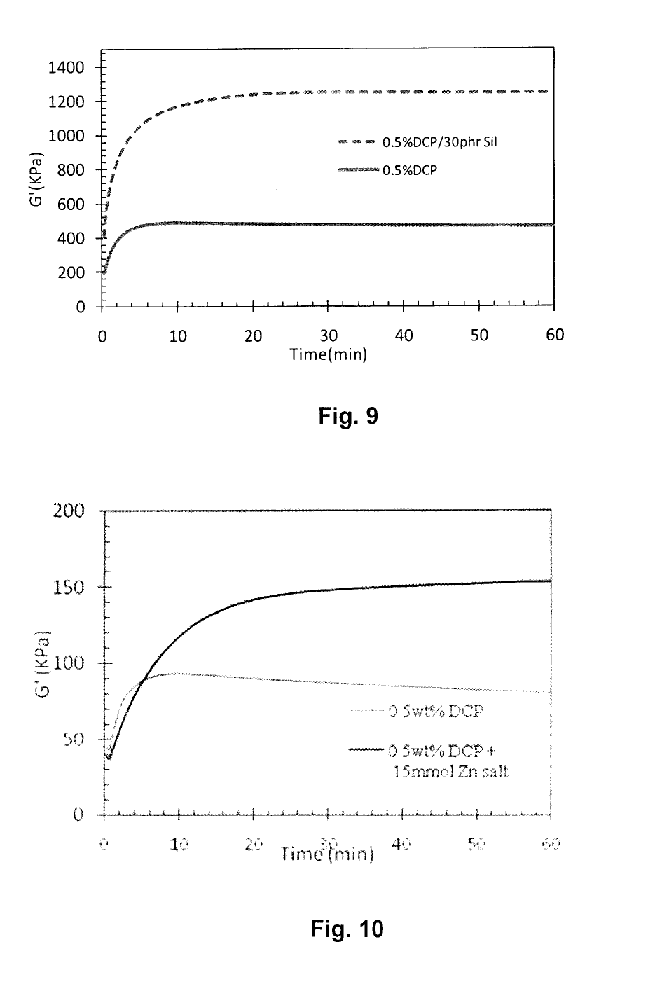

IMS-g-amidosilyl itaconate (5 g) was coated with DCP (0.092 mmol, 0.025 g) in 1-5 mL of acetone (0.092 mmol, 0.025 g DCP) and allowed to dry before passing the sample 5 times through a 2-roll mill. Evidence of substantial curing was obtained by rheometry data that is presented in FIG. 9.

IMS-g-amidosilyl itaconate (5 g) was coated with DCP (0.092 mmol, 0.025 g) in 1-5 mL of acetone (0.092 mmol, 0.025 g DCP) and allowed to dry before passing the sample 5 times through a 2-roll mill. HiSil 233 (1.5 g), 30 phr, was incorporated in to IMS-g-amidosilyl itaconate by adding it in small quantities before passing through the 2-roll mill several times. Evidence of substantial curing and silica reinforcement was obtained by rheometry data that is presented in FIG. 9.

### Example 10

### Coagent-Assisted Cure of IIR-g-Dodecyl Itaconate

Dodecanol (8.0 mmol, 1.5 g) and itaconic anhydride (24 mmol, 2.7 g) were dissolved in toluene (10 g) and heated to 80° C. for 4 hr. Residual starting materials and solvent were removed by Kugelrohr distillation (T=80° C., P=0.6 mmHg). A resulting acid-ester (0.98 g, 3.3 mmol) was treated with a 1 M solution of Bu₄NOH in methanol (3.3 ml, 3.3 mmol Bu₄NOH) to yield the desired Bu₄Ncarboxylate salt, which was isolated by removing methanol under vacuum.

BIIR (11 g) and Bu₄NBr (0.53 g, 1.65 mmol) were dissolved in toluene (100 g) and heated to 85° C. for 180 min. Bu₄Ncarboxylate salt (1.78 g, 3.3 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-dodecyl itaconate.

Dodecanol (8.0 mmol, 1.5 g) and itaconic anhydride (24 mmol, 2.7 g), were dissolved in toluene (10 g) and heated to 80° C. for 4 hr. Residual starting materials and solvent were removed by Kugelrohr distillation (T=80° C., P=0.6 mmHg). The resulting acid-ester (2.0 g, 6.7 mmol) was treated with zinc oxide (0.27 g, 3.3 mmol) in a 10 wt % methanol solution at room temperature for 60 min. Zinc di-dodecyl itaconate salt was isolated by removing the solvent by Kugelrohr distillation (T=40° C., P=0.6 mmHg).

IIR-g-dodecyl itaconate (5 g) was coated with DCP (0.092 mmol, 0.025 g) in 1-5 mL of acetone (0.092 mmol, 0.025 g DCP) and allowed to dry before passing the sample 5 times through a 2-roll mill. Zinc di-dodecyl itaconate salt (0.15 mmol, 0.27 g) was incorporated in to IIR-g-dodecyl itaconate by mixing the salt with the rubber before passing the sample through a 2-roll mill.

These samples were analyzed by cure rheometry using the method described in Example 1. Data plotted in FIG. 10 shows that the zinc salt improved the cross-link density of an IIR-g-dodecyl itaconate cure formulation, creating a vulcanizate with improved physical properties that also has ionic functionality. This vulcanizate can, therefore, be classified as a cure ionomer.

### Example 11

### Synthesis and Coagent-Assisted Curing of IIR-g-Decenyl Maleate

9-Decen-1-ol (1.7 g, 10.0 mmol) and maleic anhydride (1.33 g, 12.5 mmol) were dissolved in toluene (10 g) and heated to 80° C. for 4 hr. Residual starting materials and solvent were removed by Kugelrohr distillation (T=80° C., P=0.6 mmHg). The resulting acid-ester, monodecyl maleate, was isolated, dried and analyzed by ¹H NMR (CDCl₃): δ 6.46 (d, HOOC—CH═CH—COO—, 1H), δ 6.36 (d, HOOC—CH═CH—COO—, 1H), δ 5.74 (m, CH₂═CH—, 1H), δ 4.93 (dd, CH₂═CH—, 1H), δ 4.87 (dd, CH₂═CH—, 1H), δ 4.20 (t, —CH═CH—COO—CH₂—CH₂—O—, 2H), δ 1.97 (m, CH₂═CH—CH₂—CH₂—, 2H), δ 1.64 (m, COO—CH₂—CH₂—CH₂—, 2H), δ 1.27 (m, ═CH—CH₂—(CH₂)₅—CH₂—OOC—, 10H).

Monodecenyl maleate (0.83 g, 3.3 mmol) was treated with a 1M solution of Bu₄NOH in methanol (3.3 ml, 3.3 mmol Bu₄NOH) to yield the desired Bu₄Ncarboxylate salt, which was isolated by removing methanol under vacuum. BIIR (11 g) and Bu₄NBr (0.53 g, 1.65 mmol) were dissolved in toluene (100 g) and heated to 85° C. for 180 min. Bu₄Ncarboxylate salt (1.65 g, 3.3 mmol) was added before heating the reaction mixture to 85° C. for 60 min. The esterification product was isolated by precipitation from excess acetone, purified by dissolution/precipitation using hexanes/acetone, and dried under vacuum, yielding IIR-g-decenyl maleate. ¹H NMR (CDCl₃): δ 5.74 (m, —CH₂═CH—CH₂—, 1H), δ 4.91 (d, CH₂═CH—, 1H), δ 4.84 (d, CH₂═CH—, 1H), δ 6.19 (s, 0° C.—CH═CH—COO—, 2H), δ 3.92 (t, —CH₂—CH₂—COO—CH₂—, 2H), δ 4.58 (E-ester, ═CH—CH₂—OCO—, 2H, s), δ 4.66 (Z-ester, ═CH—CH₂—OCO—, 2H, s).

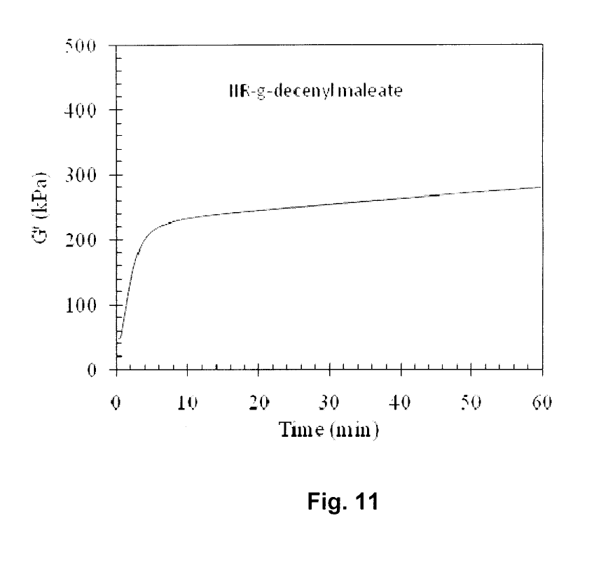

IIR-g-decenyl maleate (5 g) was coated with DCP (0.092 mmol, 0.025 g) in 1-5 mL of acetone (0.092 mmol, 0.025 g DCP) and allowed to dry before passing the sample 5 times through a 2-roll mill. The resulting compound was mixed and mixed with HVA2 (0.1 g, 0.37 mmol) by repeated passing through a 2-roll mill. Evidence of substantial curing was obtained by rheometry data that is presented in FIG. 11.

It will be understood by those skilled in the art that this description is made with reference to certain embodiments and that it is possible to make other embodiments employing the principles of the invention which fall within its spirit and scope as defined by the claims.

We claim:

1. A functional macromonomer, which comprises a polymeric main chain comprising poly(isobutylene-co-isoprene), poly(isobutylene-co-methylstyrene), poly(2-chloro-1,3-butadiene), poly(ethylene-co-propylene-co-ethylidene norbornadiene), or poly(ethylene-co-propylene) and a plurality of side chains bonded to the main chain that comprise a substituted acrylate moiety,
wherein at least one substituent of the substituted acrylate moiety comprises a functional moiety; and
wherein the functional macromonomer is capable of homopolymerization initiated by a free-radical initiator.

2. The functional macromonomer of claim 1, wherein the structure of the functional macromonomer is 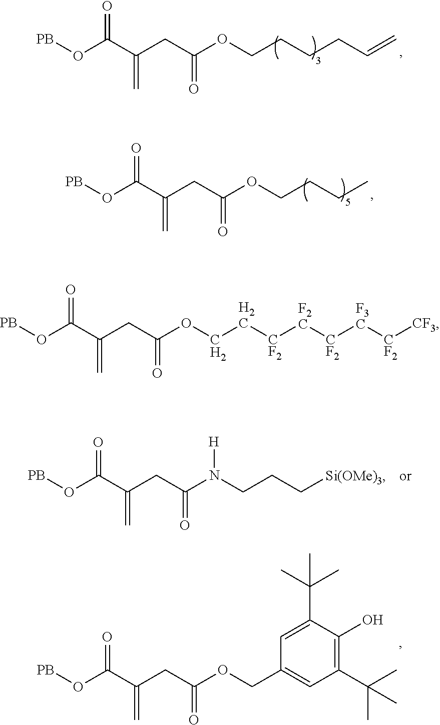
wherein respective moieties attached to PB represent one of the plurality of side chains and PB represents remaining portion of the macromonomer.

3. A cross-linked polymer prepared by reacting the functional macromonomer of claim 1 with a free-radical initiator.

4. An innerliner composition comprising the cross-linked polymer of claim 3.

5. A method of crosslinking halogenated isobutylene-rich elastomers, comprising:
subjecting to a free-radical initiator a mixture of (i) a cyclic anhydride, (ii) a functional nucleophile, (iii) a halogenated elastomer, and (iv) a base; and
allowing reactions to occur such that crosslinking-bonds form and cross-linked product is obtained.

6. The method of claim 5, wherein the cyclic anhydride and the functional nucleophile are mixed together separately from mixing either of them with the halogenated elastomer and the base.

7. A kit comprising:
the functional macromonomer of claim 1;
optionally, a free-radical initiator; and
instructions for use of the kit comprising directions to subject the macromonomer to free-radical initiation to form a cross-linked polymer.

8. The kit of claim 7, wherein the instructions comprise printed material, text or symbols provided on an electronic-readable medium, directions to an internet web site, or electronic mail.

9. A method for making a functional macromonomer comprising:
combining a mixture of a functional nucleophile and itaconic anhydride, citraconic anhydride or phenyl maleic anhydride, with a halogenated elastomer and a base.

10. The method of claim 9, further comprising combining a solvent for dissolving the halogenated elastomer.

11. The method of claim 9, further comprising combining a phase transfer catalyst.

12. The method of claim 9, wherein the functional nucleophile is a compound of formula (10) or a compound of formula (11) 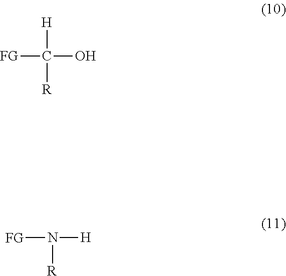
where
R is hydrogen, a C₁₋₁₂ aliphatic group, or an aryl group; and
FG is functional group comprising alkyl, aryl, phenyl, halogen, silane, alkoxysilane, phenolic, aryl alcohol, ether, thioether, aldehyde, ester, thioester, dithioester, carbonate, carbamate, amide, imide, nitrile, imine, enamine, olefin, vinyl, alkyne, phosphate, phosphonate, phosphonium, sulfate, sulfonate, sulfoxide, ammonium, imidazolium, pyridinium, thiazolium, nitroxyl, fluorinated aliphatic, imidazole, pyridine, thiazole, or a combination thereof.

13. The method of claim 9, wherein the halogenated elastomer is brominated poly(isobutylene-co-isoprene) (BIIR), chlorinated polyisobutylene-co-isoprene) (CIIR), brominated polyisobutylene-co-para-methylstyrene) (BIMS), polychloroprene, or halogenated poly(ethylene-co-propylene-co-diene monomer) (EPDM).

14. The method of claim 9, wherein the base is Bu₄NOH, KOH, or NaOH.

15. The method of claim 9, wherein the mixture comprises itaconic anhydride.

16. The method of claim 15, wherein the functional nucleophile is 9-decenol or 1H,1H,2H,2H-perfluoro-1-octanol.

17. The method of claim 15, wherein the functional nucleophile is aminopropyltrimethoxysilane.

18. The functional macromonomer of claim 1, wherein the cyclic anhydride comprises maleic anhydride, citraconic anhydride, phenyl maleic anhydride, or itaconic anhydride.

19. The functional macromonomer of claim 1, further comprising one or more filler.

20. The functional macromonomer of claim 1, wherein the free-radical initiator is: a chemical free-radical initiator, a photoinitiator, heat, heat in the presence of oxygen, thermo-mechanical means, electron bombardment, irradiation, high-shear mixing, photolysis (photo-initiation), ultraviolet light, electron beam radiation, radiation bombardment, electron bombardment, or a combination thereof.

21. The functional macromonomer, wherein the chemical free-radical initiator is an organic peroxide, a hydroperoxide, bicumene, dicumyl peroxide, di-t-butyl peroxide, an azo-based initiator, or homolysis of an organic peroxide.

22. The method of claim 5, further comprising adding a co-agent to the mixture.

23. The method of claim 22, wherein the co-agent comprises maleimide, bis-maleimide, tris-maleimide, trimethylolpropane triacrylate, diallylisophthalate, N,N′-m-phenylenedimaleimide, N,N′-hexamethylenedimaleimide, zinc diacrylate, zinc dimethacylate, zinc di(dodecylitaconate), calcium di(decylitaconate), potassium decylitaconate or a combination thereof.
